(19) United States
(12) Patent Application Publication
(10) Pub. No.: US 2021/0284542 A1
(43) Pub. Date: Sep. 16, 2021

(54) RECYCLABLE AND/OR REUSABLE POLYMER TEMPLATES FOR PRODUCING HOLLOW SILICA PARTICLES

(71) Applicant: King Abdullah University of Science and Technology, Thuwal (SA)

(72) Inventors: Valentin O. RODIONOV, Thuwal (SA); Toby Alan SAINSBURY, Thuwal (SA); Sarah Riyadh ALMAHDALI, Thuwal (SA); Yogesh Raghunath PATIL, Thuwal (SA)

(21) Appl. No.: 17/256,881

(22) PCT Filed: Jul. 2, 2019
(86) PCT No.: PCT/IB2019/055651

§ 371 Date: Dec. 29, 2020

Related U.S. Application Data
(60) Provisional application No. 62/693,634, filed on Jul. 3, 2018.
(60) Provisional application No. 62/737,333, filed on Sep. 27, 2018.

(51) Int. Cl. C01B 33/18; C08F 212/08; C08F 220/34; C08J 3/14

(52) U.S. Cl. CPC C01B 33/18; C08F 212/08; B82Y 40/00; C08J 3/14; C08F 220/34

(57) ABSTRACT

Embodiments of the present disclosure describe methods of preparing hollow silica nanoparticles comprising one or more of the following steps: contacting a polymer and a first solvent to obtain a first solution in which the polymer is dissolved; contacting the first solution and a second solvent to obtain a second solution in which a polymer template is formed by precipitation; contacting a silica precursor and the second solution to obtain a shell-core structure in which a silica shell is formed around the polymer template; contacting the shell-core structure with a third solvent to remove the polymer template from the shell-core structure; and recovering one or more of hollow silica nanoparticles, the polymer, and the polymer template.

### BACKGROUND

Hollow particles (e.g., hollow silica nanoparticles) may be produced using various templates, such as surfactants, polymers, and hematite. Conventional methods of preparing, hollow silica nanoparticles typically involve preparing a template and then coating the template with SiO₂. Once an appropriate shell is formed, the template must then be dissolved, etched, or burned out of the core, leaving behind the hollow silica nanoparticle. The templates are thus consumed or otherwise destroyed such that they may not be used again. As a result, templates must be synthesized each time hollow silica nanoparticles are produced, which is a costly, labor-intensive, and lengthy process.

Accordingly, it would be desirable to use recyclable and/or reusable templates for the production of hollow silica nanoparticles.

### SUMMARY

In general, embodiments of the present disclosure describe recyclable and/or reusable polymer templates and methods of preparing hollow silica particles using the recyclable and/or reusable polymer templates.

Embodiments of the present disclosure describe recyclable and/or reusable polymer templates for preparing hollow silica nanoparticles comprising soluble polymer nanoparticles formed by nanoprecipitation. The polymer material may be used without being consumed or otherwise destroyed such that the polymer templates may be recovered, recycled, and/or reused to prepare additional hollow silica nanoparticles.

Embodiments of the present disclosure describe methods of preparing polymer templates comprising contacting a polymer with a first solvent to obtain a first solution in which the polymer is dissolved and contacting the first solution with a second solvent to obtain a second solution in which a polymer template is formed by precipitation.

Embodiments of the present disclosure describe methods of preparing hollow silica particles comprising one or more of the following steps: contacting a polymer with a first solvent to obtain a first solution in which the polymer is dissolved; contacting the first solution with a second solvent to obtain a second solution in which a polymer template is formed by precipitation; contacting a silica precursor with the second solution to obtain a shell-core structure in which a silica shell is formed around the polymer template; contacting the shell-core structure with a third solvent to remove the polymer template from the shell-core structure; recovering one or more of hollow silica nanoparticles, the polymer, and the polymer template; and recycling one or more of the polymer and polymer template to prepare additional hollow silica particles.

Embodiments of the present disclosure describe methods of preparing hollow silica particles comprising one or more of the following steps: contacting a polymer with a first solvent to obtain a first solution in which the polymer is dissolved; contacting the first solution with a second solvent to obtain a second solution in which a polymer template is formed by precipitation; contacting a silica precursor with the second solution to obtain a shell-core structure in which a silica shell is formed around the polymer template; and contacting the shell-core structure with a third solvent to remove the polymer template from the shell-core structure and obtain hollow silica particles.

Embodiments of the present disclosure describe methods of preparing hollow silica particles that may comprise one or more of the following steps: contacting a silica precursor with a second solution to obtain a shell-core structure in which a silica shell is formed around the polymer template, wherein the second solution contains a polymer template formed by precipitation (e.g., nanoprecipitation); and contacting the shell-core structure with a third solvent to remove the polymer template from the shell-core structure.

Embodiments of the present disclosure describe methods of preparing hollow silica particles that may comprise one or more of the following steps: contacting a silica precursor with a second solution to obtain a shell-core structure in which a silica shell is formed around the polymer template, wherein the second solution contains a polymer template formed by precipitation (e.g., nanoprecipitation); contacting the shell-core structure with a third solvent to remove the polymer template from the shell-core structure; and recovering one or more of hollow silica nanoparticles, the polymer, and the polymer template.

The details of one or more examples are set forth in the description below. Other features, objects, and advantages will be apparent from the description and from the claims.

### BRIEF DESCRIPTION OF DRAWINGS

This written disclosure describes illustrative embodiments that are non-limiting and non-exhaustive. In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

Reference is made to illustrative embodiments that are depicted in the figures, in which:

FIG. 1 is a flowchart of a method of preparing hollow silica particles, according to one or more embodiments of the present disclosure.

FIG. 2 is a flowchart of a method of preparing a polymer template, according to one or more embodiments of the present disclosure.

FIG. 3 is a flowchart of a method of preparing hollow silica particles, according to one or more embodiments of the present disclosure.

FIG. 4 is a flowchart of a method of preparing hollow silica particles, according to one or more embodiments of the present disclosure.

FIG. 5 is a flowchart of a method of preparing hollow silica particles, according to one or more embodiments of the present disclosure.

FIG. 6 is a flowchart of a method of preparing hollow silica particles, according to one or more embodiments of the present disclosure.

FIG. 7 is a schematic representation of a method of preparing hollow silica nanoparticles, according to one or more embodiments of the present disclosure. As shown in FIG. 7, the styrene/DMAEMA copolymer is precipitated from water. The inorganic silica shell is grown on the template by adding TEOS (about 0.45 mL, about 2.0 mmol) and ethanol (about 75 mL) to about 150 mL of the colloidal mixture in water and the reaction is stirred (about 20 hours, 1500 rpm, about room temperature). Afterwards, the silica is repeatedly washed and centrifuged, first in DI water and then twice more in ethanol, to solubilize the copolymer template and produce hollow silicon dioxide nanoparticles.

FIG. 8 is a schematic representation of a method of preparing hollow silica nanoparticles, according to one or more embodiments of the present disclosure. As shown in FIG. 8, (1) a polystyrene-co-poly(2-dimethylaminoethylmethacrylate) random linear copolymer is dissolved in ethanol and then nanoprecipitated from water to form (2) the spherical polymer template. Tetraethyl orthosilicate is added to the copolymer mixture and allowed to stir for about 16 hours, forming the silica shell (3). Finally, the mixture is washed several times with ethanol to obtain hollow silica nanoparticles (4). The copolymer can be recovered by removing the solvent from supernatant, and immediately reused in another cycle to produce more hollow silica nanoparticles.

FIG. 9 is a schematic representation of a method of preparing polymer templates, among other things, according to one or more embodiments of the present disclosure. As shown in FIG. 9, the PSt-co-PDMAEMA copolymer is dissolved in EtOH and then added dropwise to DI water; the mixture is stirred for about 1 hour before adding TEOS.

### DETAILED DESCRIPTION

Embodiments of the present disclosure relate to recyclable and/or reusable polymer templates that may be used to synthesize hollow silica particles, such as hollow silica nanoparticles (e.g., hollow silicon dioxide (HSiO₂) nanoparticles). While conventional polymer templates must be, for example, burned or calcinated in order to be removed from a shell-core structure, the polymer templates of the present disclosure may be removed from the shell-core structure without being consumed or otherwise destroyed. For example, the polymer templates of the present disclosure may be removed from the shell-core structure by simply contacting the shell-core structure with a solvent sufficient to dissolve and/or solubilize the polymer template. In an embodiment, the polymer templates may be removed from the shell-core structure by washing the shell-core structure with a suitable solvent, such as an alcohol solvent, among other solvents. In this way, the polymer templates may be recovered, recycled, and/or reused to prepare additional hollow silica nanoparticles.

The polymer templates may be prepared by precipitation of a polymer (e.g., nanoprecipitation of a copolymer). In particular, the polymer templates may be prepared by contacting a polymer in a first solvent (e.g., an alcohol solvent) to obtain a first solution in which the polymer is dissolved and/or solubilized. The first solution may be contacted with a second solvent (e.g., water or an aqueous solution) to obtain a second solution in which the polymer template is formed by precipitation (e.g., nanoprecipitation). The resulting polymer templates may include soluble polymer particles (e.g., soluble polymer nanoparticles) that may be used as templates to prepare hollow silica particles (e.g., hollow silica nanoparticles). The polymer templates may include functional groups, such as amines, that are capable of promoting and/or catalyzing the polymerization of a silica precursor on a surface of the polymer template, thereby alleviating the need to use conventional catalysts, such as ammonia, for the preparation of hollow silica particles.

To prepare hollow silica particles, such as hollow silica nanoparticles, (e.g., using a single solvent system), a polymer (e.g., a copolymer) may be contacted with a first solvent (e.g., an alcohol solvent) sufficient to dissolve the polymer therein and obtain a first solution. The first solution may be contacted with a second solvent (e.g., water or an aqueous solution) sufficient to precipitate (e.g., nanoprecipitate) a polymer template in a second solution. A silica precursor may be added directly to the second solution (e.g., without performing any intermediate separation step) to form a silica shell around the polymer template and obtain a shell-core structure. The shell-core structure may be contacted (e.g., washed) with a third solvent (e.g., which may be the same as the first solvent) to remove the polymer template from the shell-core structure to obtain hollow silica particles (e.g., hollow silica nanoparticles, such as hollow silicon dioxide nanoparticles). The polymer template may be recovered, recycled, and/or reused to prepare additional hollow silica particles.

The polymer templates may be prepared using solvents that are the same as or at least similar to the solvents used to prepare hollow silica particles, which may include, among others, the methods of the present disclosure, as well as Stöber or Stöber-like processes. For example, a silica precursor may be added directly to the solution in which the polymer templates were precipitated or nanoprecipitated to obtain a shell-core structure in which a silica shell is formed around the polymer template. At least one of many benefits of the polymer templates and methods of the present disclosure is that an intermediate separation step is not required prior to the addition of the silica precursor. For example, there is no requirement that the polymer templates be separated from the solution in which they were precipitated prior to adding the silica precursor. In addition, one or more of the solvents used to synthesize the polymer templates may also be used to remove the polymer template from the shell-core structure. In this way, the polymer templates and hollow silica particles may be prepared using a single solvent system, which may include one or more solvents, as the same solvents may be used for the preparation of each. An example of a single solvent system includes an alcohol and water, such as ethanol and water, which may be used to prepare the polymer templates and hollow silica nanoparticles. This greatly simplifies the synthesis of polymer templates and/or hollow silica particles, especially with respect to conventional methods.

### Definitions

The terms recited below have been defined as described below. All other terms and phrases in this disclosure shall be construed according to their ordinary meaning as understood by one of skill in the art.

As used herein, “recyclable polymer template,” “reusable polymer template,” and “recoverable polymer template” refer to any polymer and/or polymer template that may be removed from a shell-core structure without being consumed or otherwise destroyed. Such polymer templates may be capable of being used more than once, although they may only be used once.

As used herein, “contacting” refers to the act of touching, making contact, or of bringing to close or immediate proximity, including at the cellular or molecular level, for example, to bring about a physiological reaction, a chemical reaction, or a physical change (e.g., in solution, in a reaction mixture, in vitro, or in vivo). Contacting may refer to bringing two or more components in proximity, such as physically, chemically, or some combination thereof. Examples of contacting may include one or more of adding, pouring, mixing, washing, and other techniques of contacting known in the art.

As used herein, “recovering” refers to obtaining any chemical species in a process. The recovered chemical species may include the desired chemical species and one or more other chemical species. The recovered chemical species may be an isolated chemical species without any impurities, with a low concentration of impurities, or with a negligible concentration of impurities.

Embodiments of the present disclosure describe reusable and/or recyclable polymer templates for producing hollow silica particles, such as hollow silica nanoparticles. In an embodiment, the reusable and/or recyclable polymer templates may comprise soluble polymer particles formed by precipitation. For example, in an embodiment, the polymer templates may comprise soluble polymer precipitates. In an embodiment, the reusable and/or recyclable polymer templates may comprise soluble polymer nanoparticles formed by nanoprecipitation. For example, in an embodiment, the reusable and/or recyclable polymer templates may comprise soluble polymer nanoprecipitates.

The soluble polymer particles (e.g., soluble polymer nanoparticles) may include a copolymer, such as a water-insoluble copolymer. The copolymer may include one or more of a linear copolymer and a branched copolymer. For example, the copolymer may include one or more of alternating copolymers, periodic copolymers, random copolymers, block copolymers, graft copolymers, and star copolymers. The copolymers may include one or more of hydrophobic blocks and hydrophilic blocks. The copolymers may be prepared from one or more of hydrophobic monomers and hydrophilic monomers. In an embodiment, the polymer is a linear copolymer. In an embodiment, the polymer is a random linear copolymer. In an embodiment, the polymer is a copolymer including a hydrophobic block and a hydrophilic block. In an embodiment, the polymer is a copolymer including a hydrophobic block (e.g., and no hydrophilic block). In an embodiment, the polymer is a copolymer including a hydrophilic block (e.g., and no hydrophobic block).

Examples of suitable hydrophilic blocks/monomers may include one or more of 2-(dimethylamino)ethyl methacrylate, 2-(diethylamino)ethyl methacrylate, 2-(dimethylamino)ethyl acrylate, 3-(dimethylamino)-2,2-dimethylpropyl acrylate, 2-(diethylamino)ethyl acrylate, 2-(tertiary-butylamino)ethyl methacrylate, 2-(trimethylammonium)ethyl methacrylate chloride, 2-(trimethylammonium) ethyl acrylate chloride, 3-(dimethylamino)propyl methacrylamide, methacrylamidopropyl trimethylammonium chloride, diallyidimethylammonium chloride, vinylpyridine, allylamine, and monoacrylate or monomethacrylate esters of C2-C4 diols. Examples of suitable hydrophobic blocks/monomers may include one or more of polystyrene, poly(2,3,4,5-pentafluorostyrene), poly(methyl methacrylate) (PMMA); polylactic acid (PLA); polycaprolactone (PCL); polymethylacrylate (PMA), polyisoprene, polybutadiene, polydimethylsiloxane, methylphenylsiloxane, polyacrylates of C1-C4 CH alcohols, polymethacrylates of C3-C4 CH alcohols, polyacrylates of C1-C4 perfluorinated alcohols, polymethacrylates of C3-C4 perfluorinated alcohols, hydrogenated polyisoprene, and polybutadiene. In an embodiment, the soluble polymer particles (e.g., soluble polymer nanoparticles) may include polystyrene-co-poly(2-dimethylaminoethylmethacrylate) (PSt-co-PDMAEMA). In an embodiment, PSt-co-PDMAEMA is a linear copolymer. In an embodiment, PSt-co-PDMAEMA is a random linear copolymer.

The ratio, amount, and/or proportion of the hydrophobic monomer and hydrophilic monomer may be selected and/or adjusted to control a solubility of the soluble polymer particles (e.g., soluble polymer nanoparticles) in one or more of a first solvent and a second solvent. For example, in an embodiment, a ratio of the hydrophobic monomer and the hydrophilic monomer may be selected and/or adjusted such that the soluble polymer particles (e.g., soluble polymer nanoparticles) are soluble in a first solvent and insoluble in a second solvent. In an embodiment, a ratio of the hydrophobic monomer and the hydrophilic monomer may be selected and/or adjusted such that the soluble polymer particles (e.g., soluble polymer nanoparticles) are insoluble in a first solvent and soluble in a second solvent. In an embodiment, a ratio of the hydrophobic monomer and the hydrophilic monomer may be selected and/or adjusted to provide soluble polymer particles (e.g., soluble polymer nanoparticles) that may be dissolved and/or solubilized in an alcohol solvent and/or may be insoluble in water or an aqueous solution.

The hydrophobic monomer, the hydrophilic monomer, their ratio, and the mode of alternation (random, alternating, or block-copolymer) may be selected to control particle size of the resulting polymer particles (e.g., soluble polymer nanoparticles). The other factors that may be used to impact the particle size is the nature of the organic solvent (which can be any of ethanol, methanol, acetone, tetrahydrofuran, dimethylformamide, dimethylsulfoxide, or their mixtures), the concentration of the polymer, the rate of addition, and the mode and speed of stiffing. In an embodiment, the organic solvent is ethanol.

The soluble polymer particles (e.g., soluble polymer nanoparticles) may include a functional group (e.g., a nucleophilic functional group) that promotes, catalyzes, and/or is capable of promoting and/or catalyzing the formation of a silica shell around the polymer template without the use of a catalyst, such as ammonia, L-arginine, etc. For example, the hydrophilic blocks and/or hydrophilic monomers from which they are prepared may include an amine, including, but not limited to, one or more of primary amines, secondary amines, tertiary amines, and quaternary amines; a polyamine; an alcohol; or a phenol. The presence of a nucleophilic functional group, such as an amine, promotes hydrolysis of a silica precursor on a surface of the polymer template. In this way, the nucleophilic functionality may impart a hydrophilic and/or nucleophilic character to polymer templates sufficient to promote and/or catalyze polymerization of the silica precursor on the surface thereof.

The soluble polymer particles (e.g., soluble polymer nanoparticles) may be provided in any of a variety of shapes and/or sizes. For example, in an embodiment, the soluble polymer particles (e.g., soluble polymer nanoparticles) may be one or more of spherical and substantially spherical in shape. For example, in an embodiment, the soluble polymer particles (e.g., soluble polymer nanoparticles) may be spherical in shape. In an embodiment, the soluble polymer particles (e.g., soluble polymer nanoparticles) may be substantially spherical in shape. A spherical and/or substantially spherical shape shall not be limiting as the polymer templates may be provided in any shape suitable for forming hollow silica particles. For example, in other embodiments, the soluble polymer particles (e.g., soluble polymer nanoparticles) may be provided in a shape other than spherical and/or substantially spherical, such as rods. An average diameter of the soluble polymer particles (e.g., soluble polymer nanoparticles) may range from about 10 nm to about 10 μm. In an embodiment, an average diameter of the soluble polymer particles (e.g., soluble polymer nanoparticles) may range from about 90 nm to about 200 nm.

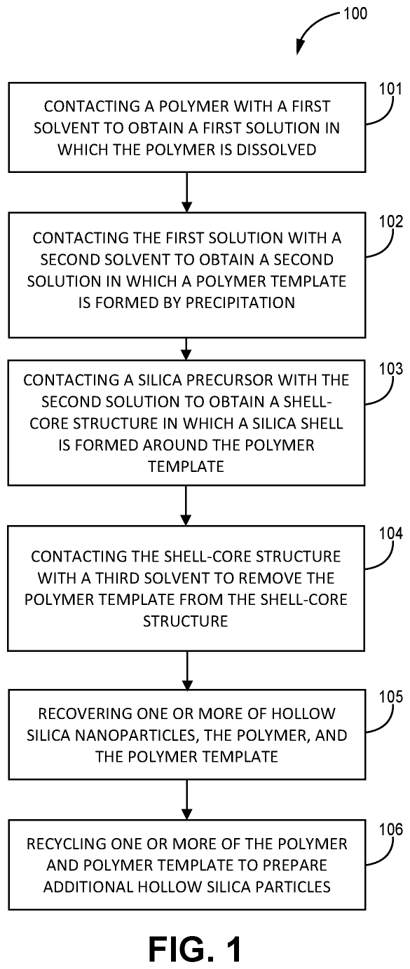

FIG. 1 is a flowchart of a method of preparing hollow silica nanoparticles, according to one or more embodiments of the present disclosure. For example, as shown in FIG. 1, the method may comprise one or more of the following steps: contacting 101 a polymer with a first solvent to obtain a first solution in which the polymer is dissolved; contacting 102 the first solution with a second solvent to obtain a second solution in which a polymer template is formed by precipitation; contacting 103 a silica precursor with the second solution to obtain a shell-core structure in which a silica shell is formed around the polymer template; contacting 104 the shell-core structure with a third solvent to remove the polymer template from the shell-core structure; recovering 105 one or more of hollow silica nanoparticles, the polymer, and the polymer template; and recycling 106 one or more of the polymer and polymer template to prepare additional hollow silica particles.

The method 100 may be performed on an industrial scale. The method 100 may be performed in a batch process and/or a continuous process. Any one of the steps 101 to 106, either alone or in combination, may be repeated using a polymer template and/or polymer recovered from step 105 (e.g., the recovered polymer template and/or polymer may be recycled in, for example, a closed loop system and/or open loop system). For example, in an embodiment, the polymer template and/or polymer recovered from step 105 may be recycled and/or reused in step 106 to prepare additional hollow silica particles.

The step 101 includes contacting a polymer with a first solvent to obtain a first solution in which the polymer is dissolved. In this step, the polymer and the first solvent are contacted sufficient to dissolve and/or solubilize the polymer in the first solvent and form the first solution. The contacting may proceed by bringing the polymer and the first solvent into physical contact and/or immediate or close proximity. The contacting may proceed by one or more of adding, mixing, and pouring, among other forms of contacting, in any order. For example, in an embodiment, the contacting may proceed by adding the polymer to the first solvent to form the first solution. In an embodiment, the contacting may proceed by adding the first solvent to the polymer to form the first solution. These are provided as examples and shall not be limiting as any technique known in the art for contacting may be used herein.

The polymer may include a copolymer, such as a water-insoluble copolymer. The copolymer may include one or more of a linear copolymer and a branched copolymer. For example, the copolymer may include one or more of alternating copolymers, periodic copolymers, random copolymers, block copolymers, graft copolymers, and star copolymers. The copolymers may include one or more of hydrophobic blocks and hydrophilic blocks. The copolymers may be prepared from one or more of hydrophobic monomers and hydrophilic monomers. In an embodiment, the polymer is a linear copolymer. In an embodiment, the polymer is a random linear copolymer. In an embodiment, the polymer is a copolymer including a hydrophobic block and a hydrophilic block. In an embodiment, the polymer is a copolymer including a hydrophobic block (e.g., and no hydrophilic block). In an embodiment, the polymer is a copolymer including a hydrophilic block (e.g., and no hydrophobic block).

Examples of suitable hydrophilic blocks/monomers may include one or more of 2-(dimethylamino)ethyl methacrylate, 2-(diethylamino)ethyl methacrylate, 2-(dimethylamino)ethyl acrylate, 3-(dimethylamino)-2,2-dimethylpropyl acrylate, 2-(diethylamino)ethyl acrylate, 2-(tertiary-butylamino)ethyl methacrylate, 2-(trimethylammonium)ethyl methacrylate chloride, 2-(trimethylammonium) ethyl acrylate chloride, 3-(dimethylamino)propyl methacrylamide, methacrylamidopropyl trimethylammonium chloride, diallyidimethylammonium chloride, vinylpyridine, allylamine, and monoacrylate or monomethacrylate esters of C2-C4 diols. Examples of suitable hydrophobic blocks/monomers may include one or more of polystyrene, poly(2,3,4,5-pentafluorostyrene), poly(methyl methacrylate) (PMMA); polylactic acid (PLA); polycaprolactone (PCL); polymethylacrylate (PMA), polyisoprene, polybutadiene, polydimethylsiloxane, methylphenylsiloxane, polyacrylates of C1-C4 CH alcohols, polymethacrylates of C3-C4 CH alcohols, polyacrylates of C1-C4 perfluorinated alcohols, polymethacrylates of C3-C4 perfluorinated alcohols, hydrogenated polyisoprene, and polybutadiene. In an embodiment, the polymer is polystyrene-co-poly(2-dimethylaminoethylmethacrylate) (PSt-co-PDMAEMA). In an embodiment, PSt-co-PDMAEMA is a linear copolymer. In an embodiment, PSt-co-PDMAEMA is a random linear copolymer.

One or more of the hydrophobic blocks, hydrophobic monomers form which the hydrophobic blocks are prepared, hydrophilic blocks, and hydrophilic monomers from which they are prepared may be selected such that a silica shell may be formed around the polymer template in an absence of a catalyst. While conventional methods require the addition of a catalyst (e.g., ammonia, L-arginine, etc.) in order to form and/or promote the formation of the silica shell, the polymers (e.g., copolymers, water-insoluble copolymers, etc.) of the present disclosure may include a functional group that promotes and/or is capable of promoting the formation of the silica shell around the polymer template without the use of any such catalyst. For example, the hydrophilic blocks and/or hydrophilic monomers form which they are prepared may include a polyamine; amine, including, but not limited to, one or more of primary amines, secondary amines, tertiary amines, and quaternary amines; alcohol; or phenol. The presence of a nucleophilic functional group promotes hydrolysis of a silica precursor on a surface of the polymer template. In this way, the nucleophilic functionality of the polymers may impart a hydrophilic and/or nucleophilic character to the polymers and polymer templates sufficient to promote and/or catalyze polymerization of the silica precursor on the surface thereof.

The ratio, amount, and/or proportion of the hydrophobic monomer and hydrophilic monomer may be selected and/or adjusted to control a solubility of the copolymer in one or more of the first solvent and the second solvent. For example, in an embodiment, a ratio of the hydrophobic monomer and the hydrophilic monomer may be selected and/or adjusted such that the copolymer is soluble in a first solvent and insoluble in a second solvent. In an embodiment, a ratio of the hydrophobic monomer and the hydrophilic monomer may be selected and/or adjusted such that the copolymer is insoluble in a first solvent and soluble in a second solvent. In an embodiment, a ratio of the hydrophobic monomer and the hydrophilic monomer may be selected and/or adjusted to provide a water-insoluble copolymer that may be dissolved and/or solubilized in an alcohol solvent and/or may be precipitated (e.g., nanoprecipitated) in an aqueous solution. In an embodiment, the proportions of the hydrophilic block and the hydrophobic block in the copolymer may be selected such that the copolymer is soluble in the alcohol solvent, such as ethanol. For example, in one embodiment, the copolymer may be PSt-co-PDMAEMA, wherein the proportion of PDMAEMA is about 71% or greater, with the balance polystyrene, wherein the copolymer is soluble in the alcohol solvent (e.g., ethanol) and insoluble in water.

The hydrophobic monomer and hydrophilic monomer may be selected to control a particle size of the polymer template and/or hollow silica nanoparticles. The template particle size can be controlled through changing multiple variables, as described above and elsewhere herein. For example, the size and properties of the silica shell can be changed by varying the SiO₂ precursor (triethoxysilane, any of the CH organosilanes, etc.) and the conditions for the Stober process, such as pH, concentration of the SiO₂ precursor, temperature, solvent composition, and reaction time. A longer hydrolysis time typically yields thicker SiO₂ shells.

The first solvent may include any solvents capable of and/or suitable for solubilizing and/or dissolving the polymer (e.g., copolymer). For example, in an embodiment, the solvent is one in which the polymer dissolves. In an embodiment, the solvent is one in which the polymer is soluble. In an embodiment, the first solvent includes one or more solvents known in the art that are suitable and/or potentially suitable for the Stober process and/or Stober-like processes. In an embodiment, the first solvent includes one or more solvents that are suitable for nanoprecipitation and for the Stober process and/or Stober-like processes. In an embodiment, the first solvent includes an alcohol solvent. For example, the alcohol solvent may include one or more of methanol and ethanol. In an embodiment, the alcohol solvent is methanol. In an embodiment, the alcohol solvent is ethanol. In an embodiment, the first solvent includes one or more solvents that are water-miscible solvents. In an embodiment, the first solvent includes one or more of acetone, THF, DMF, and DMSO.

The step 102 includes contacting the first solution with a second solvent to obtain a second solution in which a polymer template is formed by precipitation. In this step, the contacting of the first solution (which may contain at least the polymer (e.g., solubilized and/or dissolved polymer) and first solvent) and the second solvent may precipitate and/or nanopreciptiate the polymer template, which may be suspended and/or floating in a mixture of the first solvent and the second solvent. The contacting may proceed by one or more of adding, mixing, stirring, and pouring, among other forms of contacting, in any order. For example, in an embodiment, the contacting may include adding the first solution to the second solvent. In an embodiment, the contacting may include adding the second solvent to the first solution. In an embodiment, the contacting may proceed by dropwise addition of one of the first solution and the second solvent to the other solution/solvent. These are provided as examples and shall not be limiting as any technique known in the art suitable for contacting may be used herein.

Whereas the first solution may include a solvent (e.g., the first solvent) in which the polymer is soluble and/or dissolves, the second solvent may generally include any solvent in which the polymer is not soluble (e.g., is insoluble) and/or does not dissolve. While it may be desirable to use, as the second solvent, a solvent that is miscible in the first solvent (e.g., to promote nanoprecipitation by rapid desolvation of the polymer), solvents that are immiscible in the first solvent may also be used. For example, in an embodiment, the second solvent may be miscible in the first solvent. In an embodiment, the second solvent may be immiscible in the first solvent. Examples of suitable second solvents include, but are not limited to, water and/or aqueous solutions. In this way, the first solution containing the dissolved and/or solubilized polymer is contacted with, as the second solvent, a solvent (e.g., the second solution) in which it is not soluble and/or does not dissolve to promote precipitation or nanoprecipitation of the polymer template.

The polymer templates may be provided in a form of spherical and/or substantially spherical particles and/or nanoparticles, among other shapes. For example, in an embodiment, the polymer template is provided in a form of spherical and/or substantially spherical particles. In an embodiment, the polymer template is provided in a form of spherical and/or substantial spherical nanoparticles. As described above and elsewhere herein, a size of the polymer template may be controlled through, among other things, one or more of pH of the solution, selection solvents and polymer (e.g., how soon the “bad” solvent precipitates the polymer), fluid mechanics of the polymer solution microdroplets, rate of stiffing, and composition of the polymer. In general, other variables and combinations of variables may be selected and/or adjusted, as this is a multi-variable system where a combination of factors can determine the outcome (e.g., particle size, among other things). An average diameter of the polymer template may be selected and/or adjusted depending on the polymer from which the polymer template is formed—for example, depending on the selection of the hydrophobic monomer and/or hydrophilic monomer, as described herein. An average diameter of the polymer template may range from about 1 nm to about 10 μm. In an embodiment, an average diameter of the polymer template may range from about 90 nm to about 200 nm. In an embodiment, the polymer template includes PSt-co-PDMAEMA.

The step 103 includes contacting a silica precursor with the second solution to form a shell-core structure. In this step, a silica shell is formed around a core including the polymer template, forming the shell-core structure. The contacting may proceed by one or more of adding, mixing, and dropping, among other forms of contacting. For example, in an embodiment, the silica precursor is added to the second solution. In an embodiment, the second solution is added to the silica precursor. These are provided as examples and shall not be limiting as any technique known in the art suitable for contacting may be used herein.

The silica precursor may include one or more of tetraalkoxysilanes, dialkoxysilanes, alkoxysilanes, silicates, colloidal silica, silicone oligomers, oligomeric silsesquioxanes, silicon polymers, and any silica precursor suitable for Stober processes. In an embodiment, the silica precursor may include one or more of tetraethoxysilane, tetrapropoxysilane, tetramethoxysilane, 1,2-bis(triethoxysilyl)ethylene, or 1,2-bis(triethoxysilyl)ethane. In an embodiment, the silica precursor is tetraethoxysilane.

The silica precursor may be added to the second solution without performing any intermediate separation step. For example, in an embodiment, the polymer template does not need to be separated from the second solution (e.g., or any other species) prior to adding the silica precursor. Instead, upon forming the polymer template, the silica precursor may be added directly to the second solution to form the silica shell around the polymer template. This may be achieved where the solvents required to form the polymer templates are the same as or at least similar to the solvents required to form the silica shell around the polymer template. In this way, a single solvent-system, which may include one or more solvents, may be used to provide an efficient method of forming hollow silica nanoparticles.

The formation of the silica shell around the polymer template may proceed in the absence of the catalyst as described herein. While conventional methods may require the addition of a catalyst (e.g., ammonia, L-arginine, etc.) in order to form and/or promote the formation of the silica shell, the polymer templates of the present disclosure may include a functional group that promotes and/or is capable of promoting the formation of the silica shell such that no catalyst is required. For example, the presence of an amine functional group on the hydrophilic monomer or block may provide an ideal template surface for the hydrolysis of the silica precursor.

The step 104 includes contacting the shell-core structure with a third solvent to remove the polymer template from the shell-core structure. In this step, the shell-core structure is contacted with the third solvent sufficient to solubilize and/or dissolve the polymer template core and remove it from the shell-core structure. The polymer template may be removed without consuming or otherwise destroying the polymer template. Rather, the contacting is sufficient to remove the polymer template core, while also preserving the polymer template, such that it may be recycled and/or reused in preparing additional hollow silica nanoparticles. The contacting may proceed by bringing the shell-core structure and the third solvent into physical contact and/or immediate or close proximity. The contacting may include washing, among other forms of contacting. The contacting may proceed one or more times. For example, in an embodiment, the shell-core structure is washed one or more times with the third solvent sufficient to remove the polymer template core from the shell-core structure. Upon contacting the shell-core structure and the third solvent, a third solution may be formed, wherein the third solution contains one or more of the solubilized and/or dissolved polymer template core, the polymer template, the original polymer of step 101, hollow silica nanoparticles, the third solvent, and one or more other solvents.

The third solvent may include any solvent capable of and/or suitable for solubilizing and/or dissolving the polymer template core from the shell-core structure. In an embodiment, the third solvent may be the same as or different from any of the solvents of the present disclosure, such as the any of the first solvents and/or second solvents described herein. For example, in an embodiment, the third solvent is the same as and/or different from one or more of the first solvent and the second solvent. In an embodiment, the third solvent is the same as the first solvent. In an embodiment, the third solvent is the same as the first solvent and different from the second solvent. In an embodiment, the third solvent is different from the first solvent and the second solvent. In an embodiment, the third solvent is the same as the second solvent. In an embodiment, the third solvent is the same as the second solvent and different from the first solvent. In an embodiment, the third solvent is the same as the first solvent and the second solvent. In an embodiment, the third solvent is ethanol. In an embodiment, the third solvent is methanol.

The hollow silica particles may include silicon dioxide. For example, in an embodiment, the hollow silica particles may include hollow silicon dioxide particles (e.g., HSiO₂ particles). The hollow silica particles may be provided in a form of hollow spherical and/or substantially spherical particles and/or nanoparticles, among other shapes. In an embodiment, the hollow silica particles include hollow silicon dioxide nanoparticles, which may be spherical and/or substantially spherical. An average diameter of the hollow silica particles may range from about 10 nm to about 10 μm. In an embodiment, an average diameter of the hollow silica nanoparticles may range from about 90 nm to about 200 nm. An average wall thickness of the hollow silica particles may range from about 1 nm to about 100 nm. In an embodiment, an average thickness of the hollow silica particles may range from about 10 nm to about 20 nm.

The step 105 includes recovering one or more of hollow silica nanoparticles, the polymer template, and the polymer. The recovering may proceed by separating the hollow silica nanoparticles from solution, which may include one or more of the solubilized and/or dissolved polymer template, the polymer template, the original polymer of step 101, the third solvent, and one or more other solvents. The recovering may include separating by one or more of centrifuging, decanting, and washing, among other forms of revering. For example, in an embodiment, the recovering may include one or more of centrifuging and decanting to separate the hollow silica nanoparticles from solution. Once separated, the hollow silica nanoparticles may optionally be redispersed in the second solution (e.g., water) and then separated from the second solution to obtain the hollow silica nanoparticles; and the solution may be collected and solvent may be removed therefrom to recover one or more of the polymer template, the original polymer of step 101, and the solubilized and/or dissolved polymer template, any of which may be recycled and/or reused to form additional hollow silica nanoparticles (e.g., in a closed loop system).

The step 106 includes recycling one or more of the polymer and polymer template to prepare additional hollow silica particles. In this step, the recycling 106 may include feed, flowing, and/or passing one or more of the polymer and the polymer template, among other techniques known in the art that are suitable for recycling. In many embodiments, the recycling may include recycling at least the polymer to step 102 such that the polymer template may be re-precipitated and/or re-nanoprecipitated in the second solvent. In other embodiments, the recycling may include recycling at least the polymer template to step 103 such that the shell-core structure may be formed.

In an embodiment, the method of preparing hollow silica particles may comprise one or more of the following steps: contacting 101 a water-insoluble polymer with an alcohol solvent to form a first solution; contacting 102 the first solution with water or an aqueous solution to obtain a second solution in which a polymer template is by nanoprecipitation; contacting 103 a silica precursor with the second solution to obtain a shell-core structure in which a silica shell is formed around the polymer template; contacting 104 the shell-core structure with the alcohol solvent to remove the polymer template core from the shell-core structure; recovering 105 one or more of hollow silica particles, the polymer template, and the water-insoluble polymer; and recycling 106 one or more of the polymer and polymer template to prepare additional hollow silica particles. Any of the steps 101 to 105 may be repeated using the polymer template and/or polymer recovered from step 105 (e.g., the recovered polymer template and/or polymer may be recycled in, for example, a closed loop system and/or open loop system).

In an embodiment, the method of preparing hollow silica nanoparticles may comprise one or more of the following steps: contacting 101 a water-insoluble copolymer with an alcohol solvent to form a first solution; contacting 102 the first solution with water or an aqueous solution to obtain a second solution in which a copolymer template is by nanoprecipitation; contacting 103 a silica precursor with the second solution to obtain a shell-core structure in which a silica shell is formed around the copolymer template; contacting 104 the shell-core structure with the alcohol solvent to remove the copolymer template from the shell-core structure; recovering 105 one or more of hollow silica nanoparticles, the copolymer template, and the water-insoluble copolymer; and recycling 106 one or more of the copolymer and copolymer template to prepare additional hollow silica particles. Any of the steps 101 to 105 may be repeated using the copolymer template and/or copolymer recovered from step 105 (e.g., the recovered copolymer template and/or copolymer may be recycled in, for example, a closed loop system and/or open loop system).

In an embodiment, the method of preparing hollow silica nanoparticles may comprise one or more of the following steps: contacting 101 a water-insoluble copolymer with one or more of ethanol and methanol to form a first solution, wherein the copolymer is polystyrene-co-poly(2-dimethylaminoethylmethacrylate); contacting 102 the first solution with water or an aqueous solution to obtain a second solution in which a copolymer template is by nanoprecipitation; contacting 103 a silica precursor with the second solution to obtain a shell-core structure in which a silica shell is formed around the copolymer template, wherein the silica precursor is tetraethyl orthosilicate; contacting 104 the shell-core structure with one or more of ethanol and methanol to remove the copolymer template from the shell-core structure; recovering 105 one or more of hollow silica nanoparticles, the copolymer template, and the water-insoluble copolymer; and recycling 106 one or more of the polymer and polymer template to prepare additional hollow silica particles. Any of the steps 101 to 105 may be repeated using the copolymer template and/or copolymer recovered from step 105 (e.g., the recovered copolymer template and/or copolymer may be recycled in, for example, a closed loop system and/or open loop system).

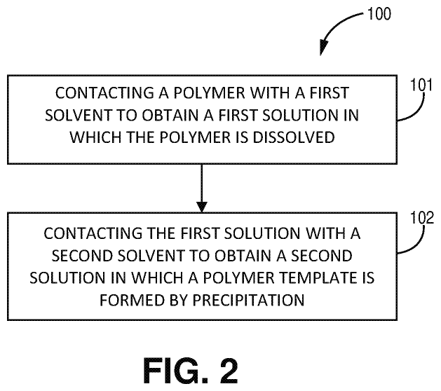

As described above, the method 100 may comprise one or more of the steps 101 to 105. In an embodiment, the method 100 may include a method of preparing polymer templates comprising at least the steps of 101 and 102. For example, in an embodiment, the method of preparing polymer templates may comprise contacting 101 a polymer with a first solvent to obtain a first solution in which the polymer is dissolved and contacting 102 the first solution with a second solvent to obtain a second solution in which a polymer template is formed by precipitation. See, for example, FIG. 2.

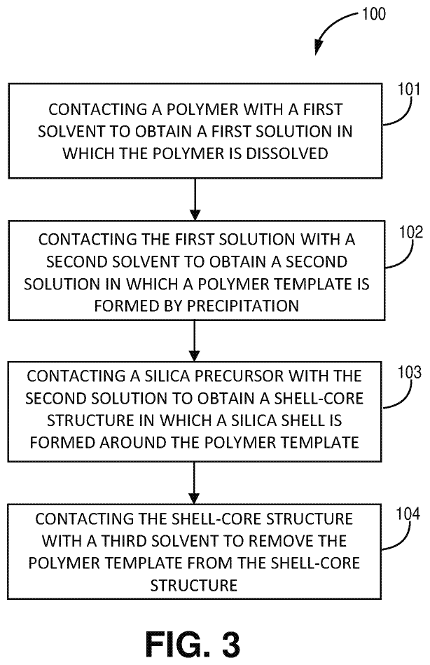

In an embodiment, the method 100 may include a method of preparing hollow silica particles comprising one or more of the steps of 101 to 104. For example, in an embodiment, the method of preparing hollow silica particles may comprise one or more of the following steps: contacting 101 a polymer with a first solvent to obtain a first solution in which the polymer is dissolved; contacting 102 the first solution with a second solvent to obtain a second solution in which a polymer template is formed by precipitation; contacting 103 a silica precursor with the second solution to obtain a shell-core structure in which a silica shell is formed around the polymer template; and contacting 104 the shell-core structure with a third solvent to remove the polymer template from the shell-core structure and obtain hollow silica particles. See, for example, FIG. 3.

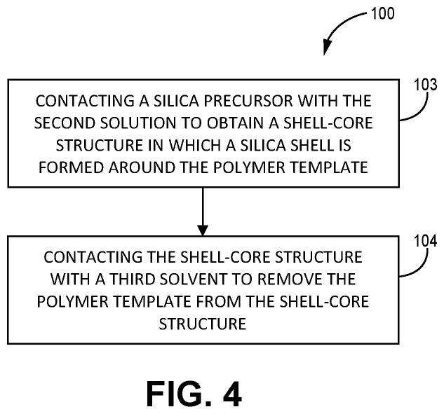

In an embodiment, the method 100 may include a method of preparing hollow silica particles comprising one or more of the steps of 103 to 104. For example, in an embodiment, the method of preparing hollow silica particles may comprise one or more of the following steps: contacting 103 a silica precursor with a second solution to obtain a shell-core structure in which a silica shell is formed around the polymer template, wherein the second solution contains a polymer template formed by precipitation (e.g., nanoprecipitation); and contacting 104 the shell-core structure with a third solvent to remove the polymer template from the shell-core structure. See, for example, FIG. 4.

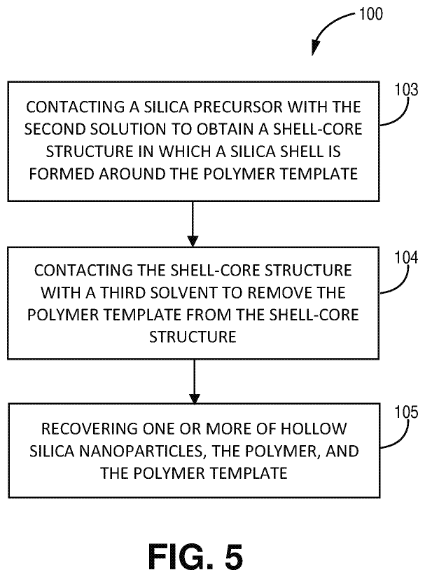

In an embodiment, the method 100 may include a method of preparing hollow silica particles comprising one or more of the steps of 103 to 105. For example, in an embodiment, the method of preparing hollow silica particles may comprise one or more of the following steps: contacting 103 a silica precursor with a second solution to obtain a shell-core structure in which a silica shell is formed around the polymer template, wherein the second solution contains a polymer template formed by precipitation (e.g., nanoprecipitation); contacting 104 the shell-core structure with a third solvent to remove the polymer template from the shell-core structure; and recovering 105 one or more of hollow silica nanoparticles, the polymer, and the polymer template. See, for example, FIG. 5.

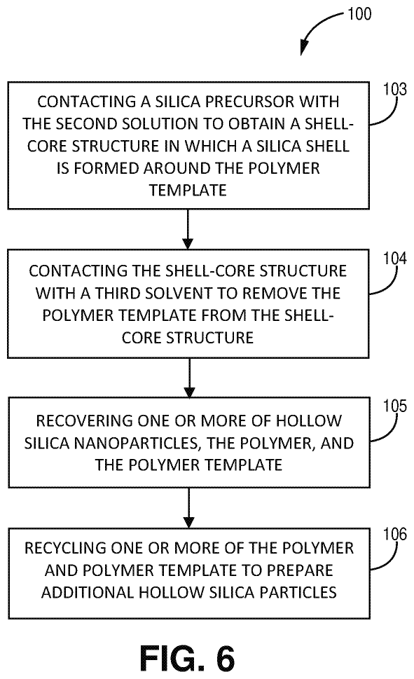

In an embodiment, the method 100 may include a method of preparing hollow silica particles comprising one or more of the steps of 103 to 106. For example, in an embodiment, the method of preparing hollow silica particles may comprise one or more of the following steps: contacting 103 a silica precursor with a second solution to obtain a shell-core structure in which a silica shell is formed around the polymer template, wherein the second solution contains a polymer template formed by precipitation (e.g., nanoprecipitation); contacting 104 the shell-core structure with a third solvent to remove the polymer template from the shell-core structure; recovering 105 one or more of hollow silica nanoparticles, the polymer, and the polymer template; and recycling 106 one or more of the polymer and polymer template to prepare additional hollow silica particles. See, for example, FIG. 6.

The following Examples are intended to illustrate the above invention and should not be construed as to narrow its scope. One skilled in the art will readily recognize that the Examiners suggest many other ways in which the invention could be practiced. It should be understand that numerous variations and modifications may be made while remaining within the scope of the invention.

### EXAMPLE 1

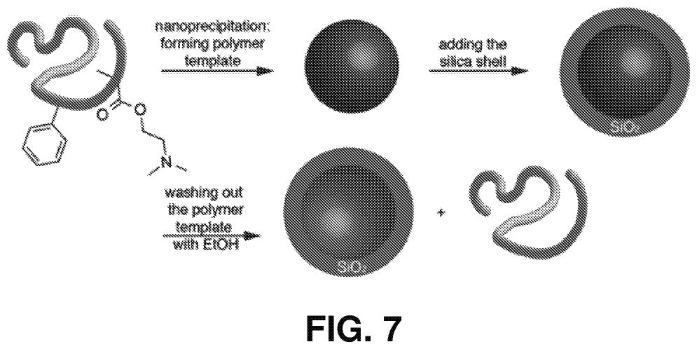

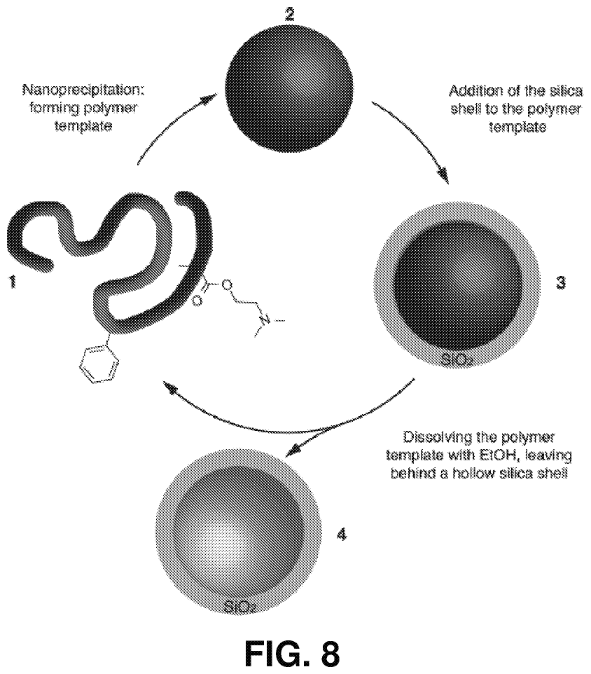

The present Example relates to a novel process for synthesizing hollow SiO (silicon dioxide) nanoparticles using a recyclable/reusable polymer template. See, for example, at least FIGS. 7 and 8. The process relies on an organic polymer template to make the process more efficient (compared to the current processes, such as the Nanosferix process) and to decrease the number of synthesis steps. A random copolymer of styrene and (dimethylarnino)ethylmethacrylate (DMAEMA), which includes two common and inexpensive monomers, was synthesized. If the proportions of styrene and DMAEMA are chosen appropriately, the copolymer may be and was soluble in 96% ethanol. The quick addition of an ethanol solution of the styrene/DMAEMA copolymer to water resulted in the spontaneous formation of polymer particles, the size of which were controlled through the rate of stirring, the pH of the solution, and the composition of the polymer. If the percentage of DMAEMA was high enough (at least 71%), then the polymer particles could also be formed by stirring the polymer in water 5.5) overnight. The polymer particles were used as seeds for the Stöber-type synthesis of SiO₂ nanoparticles using tetraethoxysilane (TEOS) as a precursor. TEOS was simply added to the dispersion of the styrene/DMAEMA particles without any preparation/separation steps. The resulting core-shell polymer/SiO₂ particles were centrifuged and washed with 96% ethanol to produce hollow SiO₂ shells and to recover the template polymer.

This is the first time a system including a recyclable polymer template is described for forming polymer-templated SiO₂ particles. Moreover, in all conventional methods, the polymers are removed through high temperature calcination. In addition, there are no previous reports of a styrene/DMAEMA template. The polymer template and/or polymer has the appropriate properties necessary for it to be soluble in 96% ethanol, insoluble in water, and to be an effective template for the polymerization of TEOS. The choice of DMAEMA monomer is just one example of a monomer that serves as a nucleophilic catalyst for the polymerization of TEOS on the surface of the particles, and that obviates the use of L-arginine, ammonia, or similar additives commonly used for the synthesis of SiO₂ nanoparticles.

### Materials and Methods

Chemicals. Styrene (St) ((≥99.0%, Sigma-Aldrich), 2-(Dimethylamino)ethyl methacrylate (DMAEMA) (98%, Sigma-Aldrich), Tetraethyl orthosilicate (TEOS) (≥99.0% (GC), (Sigma-Aldrich), Ethanol (96%, Sigma-Aldrich), Azobisisobutyronitrile (AiBN) (Sigma-Aldrich).

Transmission Electron Microscopy (TEM). Sample imaging was performed on a Titan G2 80-300 kV TEM (FEI Company) equipped with a 4 k×4 k CCD camera (model US4000) and an energy filter (model GIF Tridiem; Gatan, Inc.).

Synthesis of the poly(St-co-DMAEMA) copolymer templates. To synthesize the silica cores, the poly(St-co-DMAEMA) copolymer was first synthesized by radical polymerization. St (8.30 g, 0.0795 mol), DMAEMA, (50 g, 0.3180 mol) and dry THF (72 mL) were combined in a schlenk tube and underwent 3 freeze/pump/thaw cycles to remove oxygen. The system was frozen once more and AiBN (0.093 g, 57.0 mmol) (˜500) was added under positive argon pressure. The reaction was initiated in a 67° C. oil-bath and allowed to run for 15 hours before quenching by exposure to air. The mixture was concentrated via rotary evaporation and then the polymer was precipitated from cold n-hexane; the crude product was solubilized in THF and precipitated from cold n-hexane twice more to obtain an 80% yield of a poly(St-co-DMAEMA) copolymer with 71% DMAEMA.

The copolymer (15 mg) was then dissolved in EtOH (15 mL) and then added dropwise to 120 mL of DI water. The mixture was stirred for 1 hour before adding TEOS.

Fabrication of silica shells around the copolymer template. TEOS (30 mg, 0.144 mmol) and ethanol (15 mL) was added to the 15 mL poly(St-co-DMAEMA) copolymer mixture and allowed to stir for 20 hours (1500 rpm).

Removal of the poly(St-co-DMAEMA) copolymer templates. The nanoparticles were centrifuged down (7500 rpm) and the water/ethanol was decanted off. The nanoparticles were then washed with EtOH to solubilize the copolymer, centrifuged (7500 rpm) and the solvent decanted (3×). The system was re-dispersed in DI water and then the water was removed via lyophilization to obtain fluffy, white HSiO₂.

Discussion

Hollow silica (HSiO₂) nanospheres were easily synthesized using a recyclable/reusable copolymer template. This process was tailored to produce spheres with diameters ranging from 90-200 nm and with a wall thickness of 10-20 nm. The copolymer template was recovered and used to produce multiple batches of HSiO₂.

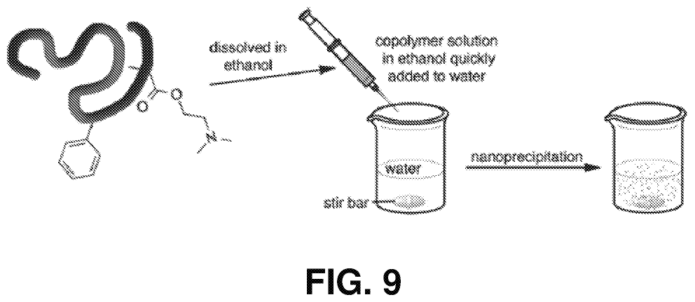

The recyclable template introduced in the present Example was composed of a linear random copolymer: polystyrene-co-poly(2-dimethylaminoethylmethacrylate) (PSt-co-PDMAEMA). By adjusting the ratio of hydrophobic St and hydrophilic DMAEMA monomers, the solubility of the linear polymer in ethanol and water was controllable and controlled. Additionally, the presence of the amine functional group on the DMAEMA monomers provided an ideal template surface for the hydrolysis of tetraethyl orthosilicate (TEOS) as it removed the need for the addition of a catalyst (such as ammonia or L-arginine) when adding the silica layer. At about 70% DMAEMA, the PSt-co-PDMAEMA linear copolymer was soluble in ethanol and insoluble in water. An ethanol solution of this copolymer underwent an easy nanoprecipitation procedure from water (FIG. 9), self-assembling into uniform, nanosized polymer templates.

Because an EtOH/water solvent system is often used for the formation of SiO₂ particles, the TEOS was simply added to the mixture to begin the formation of the SiO₂ shell. Once the desired particle size was achieved, the reaction was stopped and centrifuged down. EtOH/water were decanted off and the particles were washed repeatedly with EtOH to dissolve the PSt-co-PDMAEMA core. The EtOH was then collected and simply rotavapped off to recover the original linear copolymer.

By utilizing a recyclable template, this system reduced the cost, time, and resources necessary for the synthesis of multiple batches of hollow silica nanoparticles. DMAEMA and St are both relatively cheap monomers and the synthesis of the copolymer was very simple and efficient. The presence of DMAEMA also eliminated the necessity of adding a catalyst. In combination with the fact that the solvent system was the same and/or similar throughout the entire procedure, the production of HSiO₂ from template formation to pure product was effectively a one-pot reaction. This removed the necessity for purification steps, further reducing the cost in production time—the only purification step required was at the end and was simply centrifugation, washing, and decanting to recover the linear copolymer for additional batches. Finally, this procedure had the added benefit of only using cheap, green solvents.

Although silica nanoparticles have found many applications today, their use has been limited by their weight. This issue was solved by using hollow silica nanoparticles instead. Silica nanoparticles described herein are internally hollow and exceptionally light. Additionally, because most silica applications today rely on surface chemistry, the hollow nanoparticles described herein can also function like regular silica when used as additives, with the added advantage of being ˜100 times lighter. For example, hollow silica could replace normal silica in paints, rubber, personal care products, water filtration, food, feed, and agricultural products, plastics; ink, paints, coatings, adhesives, sealants, batteries, composites, insulators, fiber optics, glass, lights, precision casting, oil, lubricants, paper and films, insulation materials, silicon metal production, semi-conductor chip fabrication, defoamers, pharmaceuticals, fillers for composite materials, stabilizers, etc. The lighter material would not only benefit the products themselves about would also cut down on shipping costs as well.

Other embodiments of the present disclosure are possible. Although the description above contains much specificity, these should not be construed as limiting the scope of the disclosure, but as merely providing illustrations of some of the presently preferred embodiments of this disclosure. It is also contemplated that various combinations or sub-combinations of the specific features and aspects of the embodiments may be made and still fall within the scope of this disclosure. It should be understood that various features and aspects of the disclosed embodiments can be combined with or substituted for one another in order to form various embodiments. Thus, it is intended that the scope of at least some of the present disclosure should not be limited by the particular disclosed embodiments described above.

Thus the scope of this disclosure should be determined by the appended claims and their legal equivalents. Therefore, it will be appreciated that the scope of the present disclosure fully encompasses other embodiments which may become obvious to those skilled in the art, and that the scope of the present disclosure is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims.

The foregoing description of various preferred embodiments of the disclosure have been presented for purposes of illustration and description. It is not intended to be exhaustive or to limit the disclosure to the precise embodiments, and obviously many modifications and variations are possible in light of the above teaching. The example embodiments, as described above, were chosen and described in order to best explain the principles of the disclosure and its practical application to thereby enable others skilled in the art to best utilize the disclosure in various embodiments and with various modifications as are suited to the particular use contemplated. It is intended that the scope of the disclosure be defined by the claims appended hereto

Various examples have been described. These and other examples are within the scope of the following claims.

1. A method of preparing hollow silica nanoparticles, comprising:
contacting a water-insoluble copolymer with a first solvent to obtain a first solution in which the water-insoluble copolymer is dissolved;
contacting the first solution with a second solvent to obtain a second solution in which a copolymer template is formed by nanoprecipitation;
contacting a silica precursor with the second solution to obtain a shell-core structure in which a silica shell is formed around the copolymer template;
contacting the shell-core structure with a third solvent to remove the copolymer template from the shell-core structure; and
optionally recovering one or more of hollow silica nanoparticles, the copolymer template, and the water-insoluble copolymer.

2. The method of claim 1, wherein the first solvent is an alcohol solvent.

3. The method of claim 1, wherein the first solvent is one or more of methanol and ethanol.

4. The method of claim 1, wherein the water-insoluble copolymer is soluble in the alcohol solvent and is insoluble in the aqueous solution.

5. The method of claim 1, wherein the water-insoluble copolymer includes a hydrophobic block and a hydrophilic block.

6. The method of claim 5, wherein the hydrophobic block includes one or more of polystyrene, poly(2,3,4,5-pentafluorostyrene), poly(methyl methacrylate) (PMMA); polylactic acid (PLA); polycaprolactone (PCL); polymethylacrylate (PMA), polyisoprene, polybutadiene, polydimethylsiloxane, methylphenylsiloxane, polyacrylates of C1-C4 CH alcohols, polymethacrylates of C3-C4 CH alcohols, polyacrylates of C1-C4 perfluorinated alcohols, polymethacrylates of C3-C4 perfluorinated alcohols, hydrogenated polyisoprene, and polybutadiene.

7. The method of claim 5, wherein the hydrophilic block includes one or more of 2-(dimethylamino)ethyl methacrylate, 2-(diethylamino)ethyl methacrylate, 2-(dimethylamino)ethyl acrylate, 3-(dimethylamino)-2,2-dimethylpropyl acrylate, 2-(diethylamino)ethyl acrylate, 2-(tertiary-butylamino)ethyl methacrylate, 2-(trimethylammonium)ethyl methacrylate chloride, 2-(trimethylammonium) ethyl acrylate chloride, 3-(dimethylamino)propyl methacrylamide, methacrylamidopropyl trimethylammonium chloride, diallyidimethylammonium chloride, vinylpyridine, allylamine, and monoacrylate or monomethacrylate esters of C2-C4 diols.

8. The method of claim 1, wherein the second solvent is water or an aqueous solution.

9. The method of claim 1, wherein the first solvent and the second solvent are miscible or substantially miscible.

10. The method of claim 1, wherein the silica precursor is contacted with the second solution without performing any intermediate separation step to obtain the copolymer template.

11. The method of claim 1, wherein the silica precursor includes one or more of tetraalkoxysilanes, dialkoxysilanes, alkoxysilanes, silicates, colloidal silica, silicone oligomers, oligomeric silsesquioxanes, and silicon polymers.

12. The method of claim 1, wherein the third solvent is the same as the first solvent.

13. The method of claim 1, wherein the copolymer template is removed from the shell-core structure by dissolving and/or solubilizing the copolymer template.

14. The method of claim 1, wherein one or more of the water-insoluble copolymer and the copolymer template include one or more of a recovered water-insoluble copolymer and recovered copolymer template.

15. The method of claim 1, wherein the hollow silica particles include hollow silicon dioxide nanospheres.

16. The method of claim 1, wherein an average diameter of the hollow silica particles ranges from about 90 nm to about 200 nm.

17. The method of claim 1, wherein an average wall thickness of the hollow silica particles ranges from about 10 nm to about 20 nm.

18. A polymer template for preparing hollow silica nanoparticles, comprising: soluble copolymer nanoparticles formed by nanoprecipitation of a copolymer, wherein the soluble polymer nanoparticles include a hydrophobic block and a hydrophilic block including an amine; wherein the soluble copolymer nanoparticles are soluble in an alcohol solvent and insoluble in water.

19. The polymer template of claim 18, wherein the amine catalyzes polymerization of a silica precursor on a surface of the polymer template.

20. The polymer template of claim 18, wherein the soluble copolymer nanoparticles include PSt-co-PDMAEMA.
